(19) United States
(12) Patent Application Publication
(10) Pub. No.: US 2005/0188493 A1
(43) Pub. Date: Sep. 1, 2005

(54) Self-propelling cleaner

(75) Inventor: Naoya Uehigashi, Daito-shi (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/046,989

(22) Filed: Jan. 31, 2005

(30) Foreign Application Priority Data
Jan. 30, 2004 (JP) JP2004-024512

(51) Int. Cl. A47L 9/28

(52) U.S. Cl. 15/319; 15/340.1

(57) ABSTRACT

While a receiver 6 receives radio wave of a predetermined frequency transmitted from a transmitter 11, a self-propelling cleaner 1 operates a main body in a silent mode and sets the propelling speed of the main body to a low speed lower than a normal speed irrespective whether the selected operation mode is a normal mode or the silent mode, so that noise generated from the main body can be reduced. Thus, so long as a user merely places the transmitter 11 nearby, noise generated from the main body can be reduced when the self-propelling cleaner 1 approaches the user, so that the user's action taken at this time can not be interfered by noise generated from the self-propelling cleaner 1.

### BACKGROUND OF THE INVENTION

1. Field of the Invention

The present invention relates to a self-propelling cleaner in which a main body is propelled autonomously and collects dust fallen on a floor to clean the floor.

2. Description of the Related Art

Conventionally, of vacuum cleaners each of which is arranged to collect dust fallen on a floor from a nozzle into a dust chamber formed within a main body, there is one type which is configured to switch the rotation speed of a suction fan stepwise through the operation of a user (for example, see JP-A-2001-211680). For example, there is a type of a vacuum cleaner which can be switched between a normal mode having the high rotation speed of a suction fan and a silent mode having the rotation speed of the suction fan lower than the normal mode. The normal mode is arranged to make the rotation speed of the suction fan higher than that of the silent mode thereby to increase the suction power at a nozzle. Thus, in the normal mode, although an amount of dust remained not being sucked can be suppressed, noise generated from a main body is large. In the case of using a vacuum cleaner during a time period such as night where noise generated from a main body annoys the people in the neighborhood, most users selects the silent mode. In contrast, in the case of suppressing an amount of dust remained not being sucked and further using a vacuum cleaner during a time period where noise generated from a main body does not so annoy the people in the neighborhood, most users selects the normal mode.

Further, in recent years, a self-propelling cleaner has been proposed which collects dust fallen on a floor etc. while a main body propels a cleaning area set by a user. Of such self-propelling cleaners, there is one type which can select one of the normal mode and the silent mode.

### SUMMARY OF THE INVENTION

However, most users using the self-propelling cleaners take actions such as watching of a television or studying irrespective of the cleaning operation started by the self-propelling cleaner when the main body thereof is operated and instructed to start cleaning. On the other hand, the self-propelling cleaner propels and cleans near a user when a place where the user watches a television or studies is within or near a cleaning area set in the main body. In this case, when the user selects the normal mode because the vacuum cleaner is used during the time period where noise generated from the main body does not so annoy the people in the neighborhood and the user wants to suppress an amount of dust remained not being sucked, there arises a problem that the user's action such as watching of a television or studying is interfered due to noise generated from the self-propelling cleaner when the self-propelling cleaner approaches the user.

One of objects of the invention is to provide a self-propelling cleaner which is arranged to, when cleaning near a user, switch to a silent mode where noise generated from a main body is relatively small even when a selected mode is a normal mode.

According to a first aspect of the invention, there is provided a self-propelling cleaner including: a main body; an autonomous propelling unit that autonomously propels the main body; a suction unit that rotates a suction fan to collect dust within the main body from a nozzle formed at the main body; a cleaning unit that operates the suction unit to collect dust from the nozzle while controlling the autonomous propelling unit to propel the main body within an area set in advance; and a receiver that receives radio wave of a predetermined frequency transmitted from a transmitter provided separately from the main body, wherein the cleaning unit controls rotation speed of the suction fan of the suction unit in accordance with a signal level of the radio wave received by the receiver, wherein the cleaning unit controls the suction unit to switch into a silent mode when the signal level is equal to or more than a predetermined threshold level, the silent mode at which the rotation speed of the suction fan is configured to be lower than that at a normal mode, and wherein the cleaning unit controls a propelling speed of the main unit propelled by the autonomous propelling unit to be lower than that in the normal mode when in the silent mode.

According to a second aspect of the invention, there is provided a self-propelling cleaner including: a main body; an autonomous propelling unit that autonomously propels the main body; a suction unit that rotates a suction fan to collect dust within the main body from a nozzle formed at the main body; a cleaning unit that operates the suction unit to collect dust from the nozzle while controlling the autonomous propelling unit to propel the main body within an area set in advance; and a receiver that receives radio wave of a predetermined frequency transmitted from a transmitter provided separately from the main body, wherein the cleaning unit controls rotation speed of the suction fan of the suction unit in accordance with a signal level of the radio wave received by the receiver.

According to a third aspect of the invention, there is provided a self-propelling cleaner system including: a self-propelling cleaner; and a transmitter provided separately from the self-propelling cleaner and transmits radio wave of a predetermined frequency, wherein the self-propelling cleaner includes: a main body; an autonomous propelling unit that autonomously propels the main body; a suction unit that rotates a suction fan to collect dust within the main body from a nozzle formed at the main body; a cleaning unit that operates the suction unit to collect dust from the nozzle while controlling the autonomous propelling unit to propel the main body within an area set in advance; and a receiver that receives the radio wave transmitted from the transmitter, wherein the cleaning unit controls rotation speed of the suction fan of the suction unit in accordance with a signal level of the radio wave received by the receiver.

### BRIEF DESCRIPTION OF THE DRAWINGS

The above objects and advantages of the present invention will become more apparent by describing preferred exemplary embodiments thereof in detail with reference to the accompanying drawings, wherein:

FIG. 1 is a block diagram showing the configuration of the main portion of the self-propelling cleaner according to an embodiment of the invention;

FIG. 2 is a schematic sectional diagram showing the inner configuration of the self-propelling cleaner according to the embodiment;

FIG. 3 is a diagram showing areas to which radio wave of a predetermined frequency transmitted from a transmitter reaches; and

FIG. 4 is a flowchart showing the operation of the self-propelling cleaner according to the embodiment.

### DETAILED DESCRIPTION OF THE PREFERRED EMBODIMENTS

A self-propelling cleaner according to an embodiment of the invention will be explained with reference to drawings.

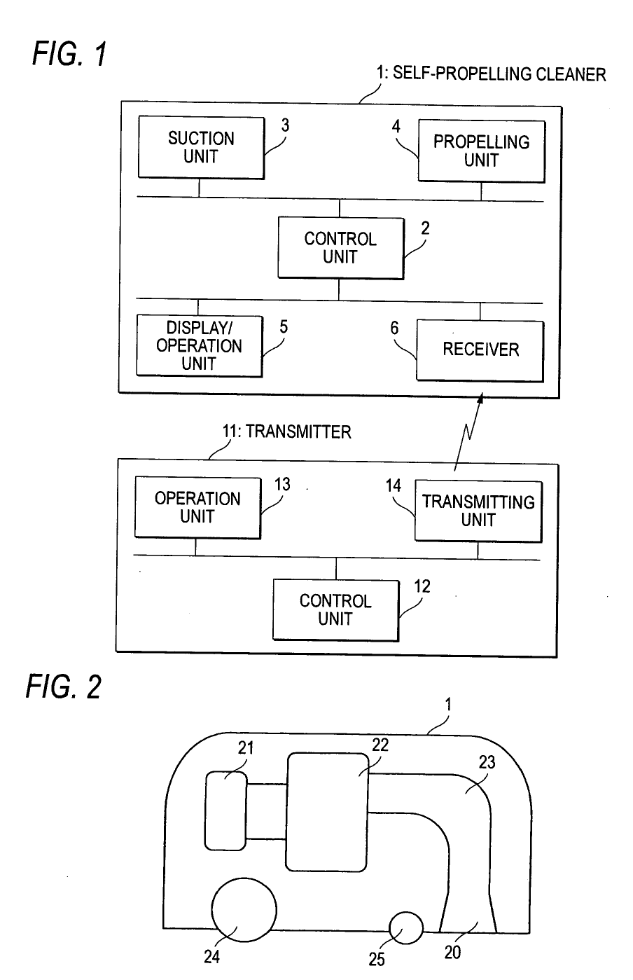

FIG. 1 is a block diagram showing a configuration of a main portion of the self-propelling cleaner according to the embodiment of the invention. FIG. 2 is a schematic diagram showing an inner configuration of the self-propelling cleaner. The self-propelling cleaner 1 includes a control unit 2 for controlling the operation of a main body, a suction unit 3 for rotating a suction fan 21 to generate suction force for sucking dust from a nozzle 20 into the main body, a propelling unit 4 for driving the driving wheels 24 of the main body to propel the main body, a display/operation unit 5 for displaying the status of the main body and accepting an input operation for the main body, and a receiver 6 for receiving radio wave of a predetermined frequency generated from a transmitter 11.

The suction unit 3 controls the rotation speed of the suction fan 21 based on an instruction from the control unit 2. Although the further the rotation speed of the suction fan 21 is increased, the larger the suction force of the nozzle 20 becomes, noise generated by the rotation of the suction fan 21 becomes also larger. In this case, the suction unit 3 rotates the suction fan 21 at a normal rotation speed or a silent rotation speed which is made lower than the normal rotation speed. In other words, the control unit 2 instructs one of the normal rotation speed and the silent rotation speed to the suction unit 3. Dust sucked from the nozzle 20 into the main body passes through a pipe 23 and collected within a dust chamber 22. The suction fan 21 is configured to be rotated by a brushless motor and the suction unit 3 controls the rotation of the brushless motor by the known PWM (pulse-width modulation) control method. Further, the propelling unit 4 controls the propelling speed of the main body in accordance with an instruction from the control unit 2. To be concrete, the propelling unit 4 controls the rotation of a motor which rotates the driving wheels 24 for propelling the main body in accordance with an instruction from the control unit 2. A reference numeral 25 depicts driven wheels. Each of the driving wheels 24 and the driven wheels 25 are formed by a pair of wheels which are disposed in an opposite manner with a suitable distance therebetween so as to secure the stability of the main body at the time of propelling the main body. The motor for driving the driving wheels 24 is also controlled in its rotation based on the PWM control by the propelling unit 4. The propelling unit 4 separately controls the rotation speeds of the two driving wheels 24 thereby to control the propelling direction of the main body. On the display/operation unit 5, keys etc. such as a key for setting a cleaning area for the main body and a key for selecting one of the normal mode and the silent mode are disposed.

In this embodiment, the explanation will be made as an example of the self-propelling cleaner 1 having two kinds of the operation modes of the normal mode and the silent mode as the operation modes being selectable. The normal mode is arranged to rotate the suction fan 21 at the normal rotation speed, whilst the silent mode is arranged to rotate the suction fan 21 at the silent rotation speed. Although the propelling unit 4 controls the propelling speeds of the main body in the normal mode and the silent mode so as to be same to each other, the propelling unit propels the main body at a low rotation speed lower than the normal rotation speed when instructed from the control unit 2 so as to propel at the low speed.

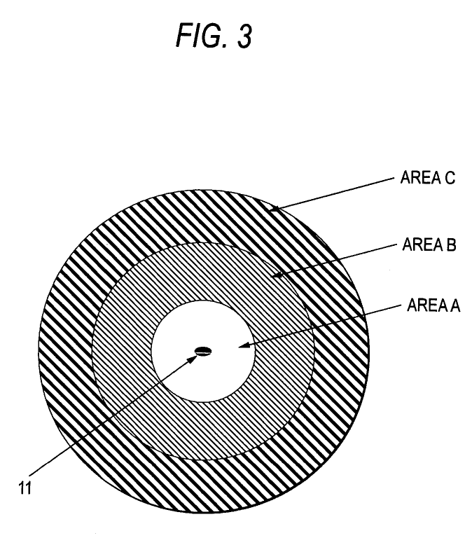

The transmitter 11 includes a control unit 12 for controlling the operation of the main body, an operating unit 13 for performing the input operation, and a transmitting unit 14 for transmitting radio wave of the predetermined frequency. As shown in FIG. 3, the transmitter 11 can switch the intensity of radio wave of the predetermined frequency transmitted from the transmitting unit 14 among three stages, that is, an intensity A where radio wave reaches to an area A around the transmitter 11, an intensity B where radio wave reaches to an area B around the transmitter, and an intensity C where radio wave reaches to an area C around the transmitter. As shown in the figure, the area B contains the area A and the area C contains the areas A and B. The operating unit 13 includes a key for selecting the intensity (the intensity A, B or C) of the radio wave of the predetermined frequency transmitted from the transmitting unit 14. The control unit 12 instructs to the transmitting unit 14 the intensity of radio wave of the predetermined frequency to be transmitted in accordance with the selection operation of a user at the operating unit 13. The transmitting unit 14 controls the intensity of radio wave of the predetermined frequency to be transmitted in accordance with the instruction from the control unit 12. The transmitter 11 has a size convenient for a user to carry and light in its weight.

Although not shown, the main body is provided with a battery for supplying operating electric power to the respective portions thereof and a sensor for detecting an obstacle such as a wall, etc.

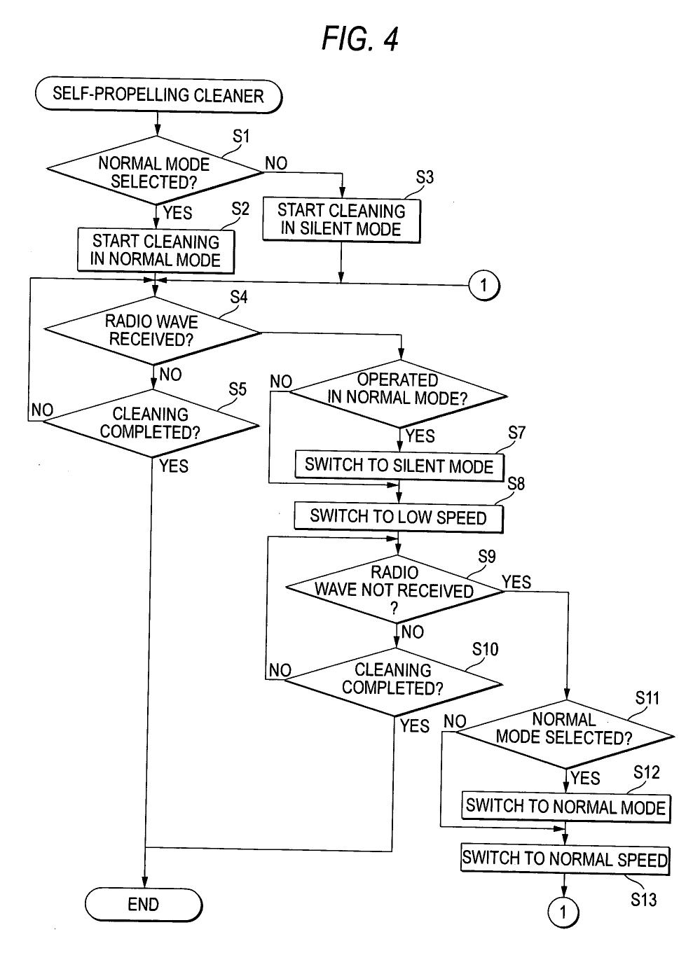

Next, the operation of the self-propelling cleaner 1 according to this embodiment will be explained. FIG. 4 is a flowchart showing the operation of the self-propelling cleaner according to this embodiment at the time of cleaning. A user inputs an instruction for starting the cleaning to the self-propelling cleaner 1. The self-propelling cleaner 1 stores in the control unit 2 cleaning area information showing a cleaning area having been set, operation mode information representing which one of the normal mode and the silent mode is selected, etc. The cleaning area information includes information representing a cleaning start position where the cleaning is started, a cleaning termination position where the cleaning is terminated, and a propelling path along which the main body is propelled between the cleaning start position and the cleaning termination position.

The self-propelling cleaner 1 determines, when the operation for starting the cleaning is performed in the display/operation unit 5, whether the selected operation mode is the normal mode or the silent mode based on the operation mode information stored in the control unit 2 (s1). The self-propelling cleaner 1 starts the cleaning in the normal mode when it is determined that the normal mode is selected in step s1 (s2), whilst starts the cleaning in the silent mode when it is determined that the silent mode is selected in step s1 (s3). In steps s2 and s3, firstly the propelling unit 4 propels the main body to the cleaning start position of the cleaning area shown by the cleaning area information stored in the control unit 2. In this case, the suction unit 3 does not rotate the suction fan 21. When the self-propelling cleaner 1 arrives at the cleaning start position, the suction unit 3 rotates the suction fan 21 at the rotation speed (the normal rotation speed or the silent rotation speed) in accordance with the operation mode determined in step s1. Then, the propelling unit 4 propels the main body along the propelling path from the cleaning start position to the cleaning termination position contained in the cleaning area information. The propelling unit 4 propels the main body at the normal speed even when any of the normal mode and the silent mode is selected.

On the other hand, a user, who inputted to the self-propelling cleaner 1 the instruction of starting the cleaning, takes an action such as watching of a television or studying irrespective of the cleaning operation started by the self-propelling cleaner 1. In this case, the user places the transmitter 11 nearby. The transmitter 11 transmits radio wave of the predetermined frequency with the set intensity from the transmitting unit 14.

When the cleaning is started at step s2 or s3, the self-propelling cleaner 1 detects whether or not radio wave of the predetermined frequency transmitted from the transmitter 11 is received at the receiver 6 (s4, s5). The self-propelling cleaner 1 receives radio wave of the predetermined frequency at the receiver 6 when the cleaner enters into an area to which radio wave of the predetermined frequency transmitted from the transmitter 11 reaches. Further, the transmitter 11 transmits radio wave of the predetermined frequency with the set intensity and a user can set stepwise the area to which radio wave of the predetermined frequency reaches.

When it is determined at step s4 that the receiver 6 receives radio wave of the predetermined frequency, the self-propelling cleaner 1 switches the operation mode to the silent mode if the current operation mode is the normal mode (s6, s7). To be concrete, the control unit 2 instructs the suction unit 3 so as to rotate the suction fan 21 at the silent rotation speed, whereby the suction unit 3 reduces the rotation speed of the suction fan 21 from the normal rotation speed to the silent rotation speed. Further, the self-propelling cleaner 1 switches the propelling speed of the main body from the normal speed to the low speed (s8). To be concrete, the control unit 2 instructs the propelling unit 4 to switch the propelling speed of the main body to the low speed and so the propelling unit 4 switches the rotation speed of the driving wheels 24 in accordance with this instruction. Thereafter, the self-propelling cleaner 1 determines until the completion of the cleaning whether or not the receiver 6 does not receive radio wave of the predetermined frequency transmitted from the transmitter 11 any longer (s9, s10).

Herein, the control unit 2 determines at step s4 whether or not the receiver 6 receives radio wave of the predetermined frequency by determining a signal level of the radio wave received by the receiver 6. In step s4, it is preferable to determine, by the control unit 2, the reception of the radio wave by determining whether or not the signal level is equal to or more than a predetermined threshold level. The predetermined threshold level may be stored in a memory provided in the control unit 2.

When the self-propelling cleaner 1 detects that radio wave of the predetermined frequency is received in step s4, the cleaner does not stop the cleaning operation but continuously executes the cleaning operation.

When it is determined at step s9 that the receiver 6 does not receive radio wave of the predetermined frequency transmitted from the transmitter 11 any longer, the self-propelling cleaner 11 restores the operation mode to the normal mode when the operation mode having been selected is the normal mode (s11, s12). To be concrete, the control unit 2 instructs the suction unit 3 to set the rotation speed of the suction fan 21 to the normal speed, whereby the suction unit 3 increases the rotation speed of the suction fan from the silent rotation speed to the normal rotation speed. Further, the self-propelling cleaner 1 switches the propelling speed of the main body from the low speed to the normal speed (s13). To be concrete, the control unit 2 instructs the propelling unit 4 to switch the propelling speed of the main body to the normal speed and so the propelling unit 4 switches the rotation speed of the driving wheels 24 in accordance with this instruction. Thereafter, the self-propelling cleaner 1 returns its operation to step s4. The self-propelling cleaner 1 repeatedly executes the steps s4 to s13 until it is determined that the cleaning operation is completed at step s5 or s10, that is, until the cleaner reaches the cleaning termination position.

In this manner, the self-propelling cleaner 1 according to this embodiment is arranged to, while the receiver 6 receives radio wave of the predetermined frequency transmitted from the transmitter 11, operate in the silent mode in which the suction fan 21 is rotated at the silent rotation speed irrespective whether the selected operation mode is the normal mode or the silent mode, so that noise caused by the rotation of the suction fan 21 can be suppressed. Further, the self-propelling cleaner 11 propels the main body at the low speed while the receiver 6 receives radio wave of the predetermined frequency. Thus, noise caused by the propelling of the main body can also be suppressed. Furthermore, since the propelling speed of the main body is set to the low speed, an amount of dust remained not being sucked can be suppressed. Accordingly, noise generated from the self-propelling cleaner 1 can be reduced while the receiver 6 receives radio wave of the predetermined frequency transmitted from the transmitter 11 placed near a user, that is, the cleaner cleans near the user. As a result, such a phenomenon can be prevented from occurring that a user's action such as watching of a television or studying is interfered by noise generated from the self-propelling cleaner 1.

Further, since a user can easily change the intensity of radio wave generated from the transmitter 11, the user can designate by oneself a range where the user worries about noise generated from the self-propelling cleaner 1, and so the usability of the cleaner is also good for the user.

Although the invention is explained as an example as to the self-propelling cleaner 1 which performs the cleaning based on the two operation modes of the normal mode and the silent mode, the invention can also be applied to a self-propelling cleaner which performs the cleaning based on at least three operation modes.

As described with reference to the embodiment, according to one aspect of the invention, there is provided a self-propelling cleaner including: a main body; an autonomous propelling unit that autonomously propels the main body; a suction unit that rotates a suction fan to collect dust within the main body from a nozzle formed at the main body; a cleaning unit that operates the suction unit to collect dust from the nozzle while controlling the autonomous propelling unit to propel the main body within an area set in advance; and a receiver that receives radio wave of a predetermined frequency transmitted from a transmitter provided separately from the main body, wherein the cleaning unit controls rotation speed of the suction fan of the suction unit in accordance with a signal level of the radio wave received by the receiver.

According to such a configuration, while the receiver receives the radio wave of the predetermined frequency from a transmitter provided separately from the main body, the cleaner operates in a silent mode at which the rotation speed of the suction fan is made lower than a normal mode. Thus, when the main body performs the cleaning near a user, so long as the user places the transmitter nearby, the cleaning is always performed in the silent mode irrespective of the selected mod. Thus, a user's action such as watching of a television or studying performed irrespective of the cleaning operation of the main body can be prevented from being interfered by noise generated from the main body.

The self-propelling cleaner may be configured that the cleaning unit controls a propelling speed of the main unit propelled by the autonomous propelling unit in accordance with the signal level.

According to such a configuration, the propelling speed of the main body is set to the low speed while the receiver receives the radio wave of the predetermined frequency. Thus, noise generated from the main body can be further reduced when the main body approaches the user and further an amount of dust remained not being sucked can be suppressed.

In the self-propelling cleaner system that includes the self-propelling cleaner and the transmitter, it is preferable to be configured that the transmitter includes an intensity adjusting unit for adjusting an intensity of the radio wave transmitted therefrom.

According to such a configuration, since the intensity of radio wave transmitted from the transmitter can be adjusted, the size of an area where the main body can receive radio wave transmitted from the transmitter, that is, the size of an area where the main body is operated in the silent mode irrespective of the current mode being selected can be adjusted easily.

According to the self-propelling cleaner, noise generated from the main body is suppressed when the main body performs cleaning near a user. Thus, a user's action such as watching of a television or studying can be prevented from being interfered by noise generated from the main body.

Although the present invention has been shown and described with reference to a specific preferred embodiment, various changes and modifications will be apparent to those skilled in the art from the teachings herein. Such changes and modifications as are obvious are deemed to come within the spirit, scope and contemplation of the invention as defined in the appended claims.

1. A self-propelling cleaner comprising:
a main body;
an autonomous propelling unit that autonomously propels the main body;
a suction unit that rotates a suction fan to collect dust within the main body from a nozzle formed at the main body;
a cleaning unit that operates the suction unit to collect dust from the nozzle while controlling the autonomous propelling unit to propel the main body within an area set in advance; and
a receiver that receives radio wave of a predetermined frequency transmitted from a transmitter provided separately from the main body,
wherein the cleaning unit controls rotation speed of the suction fan of the suction unit in accordance with a signal level of the radio wave received by the receiver,
wherein the cleaning unit controls the suction unit to switch into a silent mode when the signal level is equal to or more than a predetermined threshold level, the silent mode at which the rotation speed of the suction fan is configured to be lower than that at a normal mode, and
wherein the cleaning unit controls a propelling speed of the main unit propelled by the autonomous propelling unit to be lower than that in the normal mode when in the silent mode.

2. A self-propelling cleaner comprising:
a main body;
an autonomous propelling unit that autonomously propels the main body;
a suction unit that rotates a suction fan to collect dust within the main body from a nozzle formed at the main body;
a cleaning unit that operates the suction unit to collect dust from the nozzle while controlling the autonomous propelling unit to propel the main body within an area set in advance; and
a receiver that receives radio wave of a predetermined frequency transmitted from a transmitter provided separately from the main body,
wherein the cleaning unit controls rotation speed of the suction fan of the suction unit in accordance with a signal level of the radio wave received by the receiver.

3. The self-propelling cleaner according to claim 2, wherein the cleaning unit controls the suction unit to switch between a normal mode and a silent mode in accordance with the signal level, the silent mode at which the rotation speed of the suction fan is configured to be lower than that at the normal mode.

4. The self-propelling cleaner according to claim 3, wherein the cleaning unit controls the suction unit to switch into the silent mode when the signal level is equal to or more than a predetermined threshold level.

5. The self-propelling cleaner according to claim 2, wherein the cleaning unit controls a propelling speed of the main unit propelled by the autonomous propelling unit in accordance with the signal level.

6. The self-propelling cleaner according to claim 4, wherein the cleaning unit controls a propelling speed of the main unit propelled by the autonomous propelling unit to be lower than that in the normal mode when in the silent mode.

7. A self-propelling cleaner system comprising:
a self-propelling cleaner; and
a transmitter provided separately from the self-propelling cleaner and transmits radio wave of a predetermined frequency,
wherein the self-propelling cleaner includes:
a main body;
an autonomous propelling unit that autonomously propels the main body;
a suction unit that rotates a suction fan to collect dust within the main body from a nozzle formed at the main body;
a cleaning unit that operates the suction unit to collect dust from the nozzle while controlling the autonomous propelling unit to propel the main body within an area set in advance; and
a receiver that receives the radio wave transmitted from the transmitter,
wherein the cleaning unit controls rotation speed of the suction fan of the suction unit in accordance with a signal level of the radio wave received by the receiver.

8. The self-propelling cleaner system according to claim 7, wherein the transmitter includes an intensity adjusting unit for adjusting an intensity of the radio wave transmitted therefrom.
